(19) United States
(12) Patent Application Publication
(10) Pub. No.: US 2016/0190741 A1
(43) Pub. Date: Jun. 30, 2016

(54) KEYED CIRCUIT INTERLOCK FOR USE WITH A ROLLING CONTACT ELEMENT

(71) Applicant: MIRACO, INC., Manchester, NH (US)

(72) Inventors: Douglas Bulmer, Windham, NH (US); Jonathan Roberts, Canaan, NH (US)

(73) Assignee: MIRACO, INC., Manchester, NH (US)

(21) Appl. No.: 14/921,240

(22) Filed: Oct. 23, 2015

Related U.S. Application Data
(60) Provisional application No. 62/067,656, filed on Oct. 23, 2014.

(51) Int. Cl. H01R 13/642; H01R 12/70; H01R 43/26

(52) U.S. Cl. CPC H01R 13/642; H01R 43/26; H01R 12/7011

(57) ABSTRACT

A system of keying and interlocking interconnection systems including rolling contact elements for use with disposable medical sensors including conductive ink circuits, flexible printed circuits, and printed circuit boards. The system includes stiffening elements of sufficient thickness and rigidity to protect the conductors and provide strain relief. The system also provides for keying, aligning, and interlocking of the interconnection system by providing indentations and/or protrusions in the stiffening elements on the male portion that correspond with features on the female portion of the interconnection system.

### CLAIM OF PRIORITY

This application claims the benefit of priority of U.S. Provisional Patent Application Ser. No. 62/067,656, filed on Oct. 23, 2014.

### FIELD OF THE INVENTION

The present invention relates generally to single or multiple conductor printed conductive ink circuits, flexible printed circuits, and printed circuit boards used for disposable medical sensors, and more particularly to keyed circuit interlocks for electrical connectors containing a contact element used for interconnecting the circuits with other electrical devices.

### BACKGROUND OF THE INVENTION

There is a growing market for disposable medical sensors that are constructed using conductive printed ink circuit technology. These sensors are used in a variety of applications such as blood glucose detection, electrocardiogram (EKG/ECG) sensing, pulse oximetry sensing, and the like. Conductive ink sensors are chosen, in part, for their low manufacturing cost.

Current interconnection technology for conductive ink circuits used in medical sensors typically involves crimping formed metal contacts to the conductors and then inserting those contacts into a molded plastic housing. The company doing business as TE Connectivity offers an interconnection system product line marketed under the trademark AMPMODU. This product line includes a subcategory of connectors that use formed contacts that can be crimped to flat flexible cable (FFC) or flexible printed circuits (FPC) and then inserted into a plastic housing to form one half of an interconnection system. These interconnection systems are typically only rated for up to 200 mating cycles, with many only being rated for 25 to 50 cycles. Other current methods involve directly attaching a wire harness or circuit board to the sensor using conductive adhesive or epoxy. In either case, manufacturing the sensor includes the added cost of the crimped contact and/or the housing to the disposable portion of the system, which may, in some cases, exceed the cost of the sensor itself.

Another current interconnection technology includes ZIF (Zero Insertion Force) or LIF (Low Insertion Force) connectors. These connectors are designed for use with copper conductors. The contacts in ZIF and LIF connectors damage the printed ink conductors of the sensor due to scraping or piercing of the contact and, as such, do not create a reliable interconnect. The act of mating the cable and connector has a tendency to transfer conductive ink to the contacts of the connector, which can build up inside the connector causing electrical shorts. ZIF and LIF connectors are also very limited in durability since they are designed for only a few mating cycles.

The use of off-the-shelf connectors and components has led to other widespread problems in the disposable medical sensor industry. Namely, competitors supply counterfeit sensors that may directly interface with a manufacturer's medical instruments but that do not meet the same quality requirements as the original manufacturer's sensors. Another issue, which is of particular concern with conductive ink circuits, is that the exposed conductive ink is delicate and prone to damage due to abrasion during handling and use.

The primary application of the present invention is with disposable medical sensors, but the technology is applicable to any application where a highly reliable electrical interconnect is desired between a circuit and an electronic device, particularly when a high number of mating cycles is required (e.g., >50), or where the circuit is disposable.

Certain embodiments of the keyed circuit interlock of the present invention are designed for use with a rolling contact element, previously developed by the present inventor. The rolling contact element eliminates the need to crimp contacts onto the sensor. This reduces the overall sensor cost, at the same time significantly increasing the number of mating cycles of the mating connector. The rolling contact element also improves the reliability of the resulting interconnection system by eliminating damage to the conductive ink circuit, transfer of ink to the contact, and wear due to vibration.

The present invention eliminates the need to crimp contacts onto the sensor, thereby reducing the overall sensor cost while at the same time eliminating the possibility of producing counterfeit sensors compatible with existing medical equipment. In addition, the present invention includes features that make the disposable medical sensor more robust and provide protection for the sensitive exposed conductor(s).

### SUMMARY OF THE INVENTION

One aspect of the present invention is an electrical interconnection system, including a female portion with one or more rolling contact elements; and a male portion with a first side and a second side, wherein one or more conductors are on the first side and one or more stiffening elements are on the first side, and the stiffening element comprises one or more indentations.

One embodiment of the electrical interconnection system is wherein the one or more indentations in the stiffening element are constructed to align with one or more protrusions on the female portion to align the one or more conductors with the one or more rolling contact elements.

One embodiment of the electrical interconnection system is wherein the one or more indentations in the stiffening elements are constructed to align with one or more protrusions on the female portion to limit the engagement of the interconnection system to only one orientation.

One embodiment of the electrical interconnection system is wherein the one or more indentations in the stiffening element are constructed to interlock with one or more protrusions on the female portion to provide a safety break-away interconnection system.

One embodiment of the electrical interconnection system further also includes a stiffening element on the second side of the male portion.

One embodiment of the electrical interconnection system is wherein the stiffening element on the second side is staggered in relation to the stiffening element on the first side to provide progressive strain relief for the interconnection system.

One embodiment of the electrical interconnection system is wherein the thickness of the stiffening element on the first side prevents abrasion of the one or more conductors.

One embodiment of the electrical interconnection system is wherein the thickness of the stiffening element on the second side prevents abrasion of the one or more conductors.

Another aspect of the present invention is an electrical interconnection system, including a female portion with one or more rolling contact elements; and a male portion comprising a first side and a second side wherein one or more conductors are on the first side and one or more stiffening elements are on the first side and the stiffening element comprises one or more protrusions.

One embodiment of the electrical interconnection system is wherein the one or more protrusions in the stiffening element are constructed to align with one or more indentations on the female portion to align the one or more conductors with the one or more rolling contact elements.

One embodiment of the electrical interconnection system is wherein the one or more protrusions in the stiffening elements are constructed to align with one or more indentations on the female portion to limit the engagement of the interconnection system to only one orientation.

One embodiment of the electrical interconnection system is wherein the one or more protrusions in the stiffening element are constructed to interlock with one or more indentations on the female portion to provide a safety break-away interconnection system.

One embodiment of the electrical interconnection system also includes a stiffening element on the second side of the male portion.

One embodiment of the electrical interconnection system is wherein the stiffening element on the second side is staggered in relation to the stiffening element on the first side to provide progressive strain relief for the interconnection system.

Another aspect of the present invention is a method of electrically interconnecting using a rolling contact element. The steps of the method include: providing a female portion comprising one or more rolling contact elements; providing a male portion comprising a first side and a second side wherein one or more conductors are located on the first side; providing a stiffening element on the first side of the male portion; and aligning the one or more conductors with the one or more contact elements.

One embodiment of the method of electrically interconnecting with a rolling contact element is wherein the stiffening element is constructed to limit the engagement of the interconnection system to only one orientation.

One embodiment of the method of electrically interconnecting with a rolling contact element is wherein the stiffening element is constructed to interlock with one or more features on the female portion to provide a safety break-away interconnection system.

One embodiment of the method of electrically interconnecting with a rolling contact element is wherein the thickness of the stiffening element prevents abrasion of the one or more conductors.

One embodiment of the method of electrically interconnecting with a rolling contact element further comprises a stiffening element on the second side of the male portion.

One embodiment of the method of electrically interconnecting with a rolling contact element is wherein the stiffening element on the second side of the male portion is staggered in relation to the stiffening element on the first side to provide progressive strain relief for the interconnection system.

One embodiment of the method of electrically interconnecting with a rolling contact element is wherein one or more conductors are located on the second side of the male portion.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows examples of prior art connectors.

FIG. 2 shows an example of a prior art connector.

FIG. 3 shows a portion of one embodiment of the keyed circuit interlock of the present invention.

FIG. 4 shows one embodiment of the keyed circuit interlock of the present invention.

FIG. 5A shows a top view of one embodiment of the keyed circuit interlock of the present invention.

FIG. 5B shows a bottom view of one embodiment of the keyed circuit interlock of the present invention.

FIG. 6 shows one embodiment of the keyed circuit interlock of the present invention.

FIG. 7 shows one embodiment of the keyed circuit interlock of the present invention.

FIG. 8A shows a top view of one embodiment of the keyed circuit interlock of the present invention.

FIG. 8B shows a bottom view of one embodiment of the keyed circuit interlock of the present invention.

FIG. 8C shows one embodiment of the keyed circuit interlock of the present invention.

FIG. 8D shows one embodiment of the keyed circuit interlock of the present invention.

FIG. 8E shows one embodiment of the keyed circuit interlock of the present invention.

### DETAILED DESCRIPTION OF THE INVENTION

Conductive ink circuits, flexible printed circuits, printed circuit boards and the like are generally produced in sheet form with multiple parts on a sheet. The conductors are created either with an additive process such as screen-printing, or via a subtractive process such as chemical milling or etching. The last step of the manufacturing process is normally to die cut the circuit to separate it from the rest of the panel. To minimize cost, the preferred method of applying insulating material is to laminate it to the circuit in sheet form (in some instances around 0.030″ thick) prior to die cutting or routing the individual circuits from the sheet. The insulating material may also be applied after the circuits are cut out of the sheet although that is less cost effective.

The present invention consists of an electrically insulating material, referred to herein as “stiffening element,” which may be applied to one or both sides of a conductive ink circuit, flexible printed circuit, printed circuit board or the like. This stiffening element increases the rigidity of the circuit while simultaneously protecting any exposed conductors if applied to the same side of the conductive ink circuit or the like. The stiffening element, or stiffener, of the present invention may be constructed of electrically insulating material including, but not limited to polyester film, polyimide film, epoxy glass laminate (ex: FR4 or G10), or a variety of molded plastics. The stiffener of the present invention may be created by die cutting (stamping), laminating, molding, routing (machining), casting, or by other methods known to those of skill in the art.

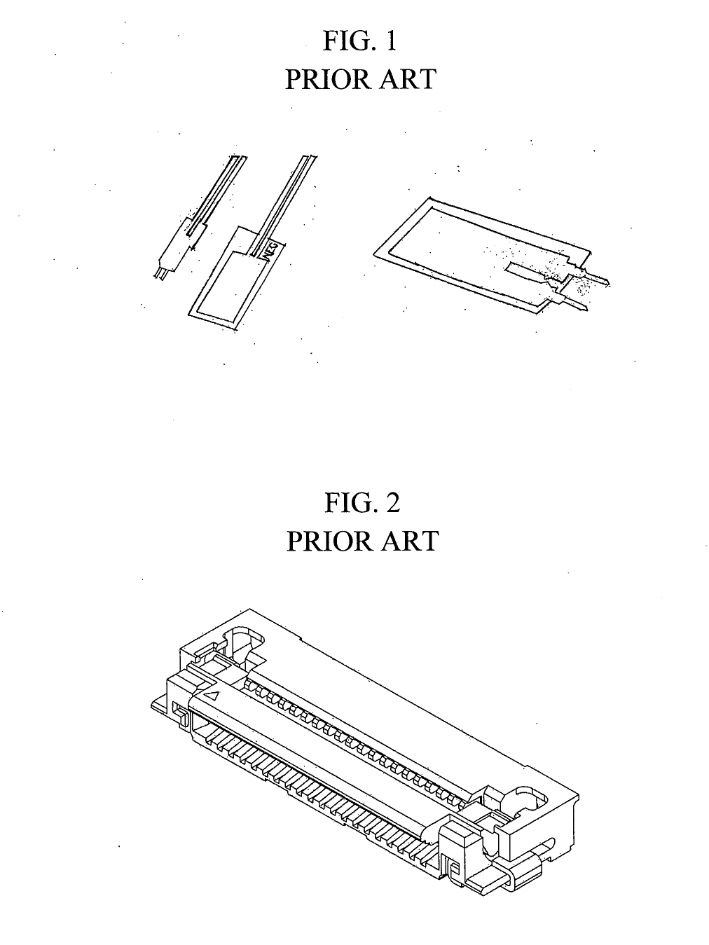

Referring to FIGS. 1 and 2, prior art connectors are shown. More particularly, formed metal contacts are crimped to the conductors and then inserted into a molded plastic housing. Alternatively, wire harnesses or circuit boards are directly attached to the sensor using conductive adhesive or epoxy.

One embodiment of inventor's previous work includes a spring loaded contact system employing a rolling contact element, which is preferably spherical in nature but could be cylindrical, or the like. In certain embodiments, the rolling contact element serves as the interface between a spring-loaded contact and the keyed circuit interlocks of a single or multi-conductor circuit of the present invention, which may be a printed conductive ink circuit, flexible printed circuit, printed circuit board, or other device similar in nature.

The rolling contact of the inventor's previous work provides a minimum contact force suitable for a reliable electrical interconnection. The minimum contact force is dependent on the substrate, conductive material, and/or plating used to construct the circuit. In certain embodiments, the rolling contact element allows an electrical interconnection to be made to the circuit, which does not pierce, scrape, or otherwise damage the circuit during the insertion/extraction (mating) cycle or during normal use.

In certain embodiments, the system also includes an insulated housing for positioning and retaining the contact system. In certain embodiments, the system further includes features such as a keyed opening, guiding surfaces, and retention springs (locking elements) for aligning to and retaining the circuit once engaged. In certain embodiments, the rolling element may be retained by a spring-loaded contact, by the insulated housing, or by other mechanisms known to those of skill in the art.

In certain embodiments, the tail end of the contact may be constructed in a variety of ways including, but not limited to, soldering to plated through-holes or pads of a printed circuit board, soldering to individual insulated wires, crimping to solid or stranded core wire, and other mechanisms known to those of skill in the art.

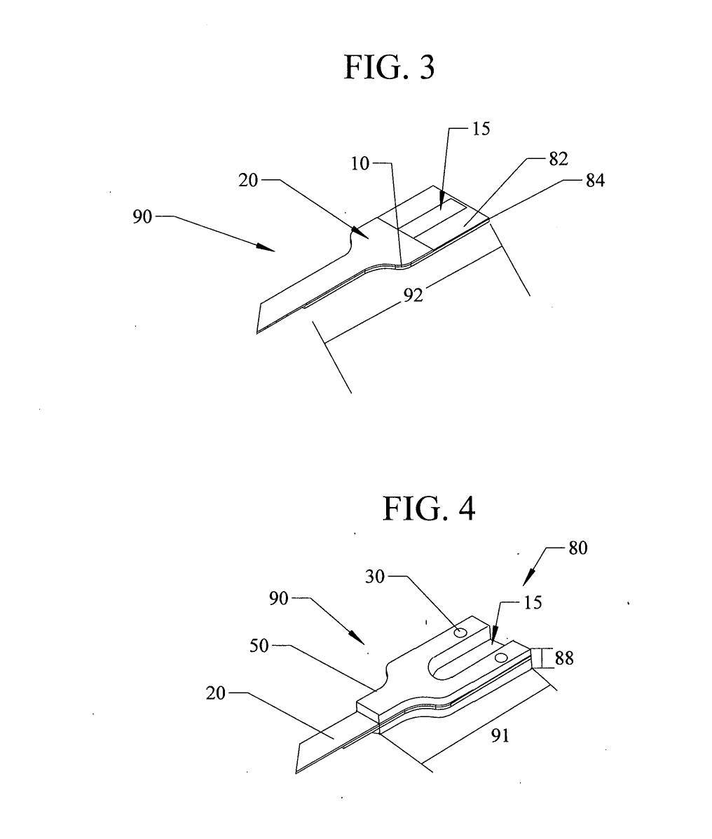

Referring to FIG. 3, one embodiment of the electrical interconnect system 2, also referred to herein as the keyed circuit interlock 2, of the present invention is shown. More particularly, male portion 90 of one embodiment of a circuit interlock 2 is shown. Male portion 90 includes first side 82 and second side 84. First side 82 includes conductor 15. The size of the conductors 15 are typically limited by disposing an insulating film 20 in areas where electrical conduction is not desired. Throughout this disclosure, one electrical contact/conductor is shown for simplicity. However, those of skill in the art will appreciate that multiple contacts/conductors may be present and form a variety of patterns. Second side 84 includes stiffening element 10 with length 92. As used herein, a stiffening element 10 includes, but is not limited to, a stiffener, an insulating material, bonding adhesive, and the like.

Referring to FIG. 4, another embodiment of the keyed circuit interlock 2 of the present invention is shown. More particularly, male portion 90 of one embodiment of a circuit interlock 2 is shown. As compared with the male portion 90 shown in FIG. 3, this male portion 90 also includes a stiffening element 50 on first side 82, opposite from stiffening element 10 on second side 84. Stiffening element 50 also has a length 91. Lengths 91 and 92 are unequal so that the degree to which the respective stiffening elements 10, 50 extend onto the cable is staggered to provide progressive strain relief. Stiffening element 50 also includes thickness 88. Thickness 88 is sufficiently thick so as to prevent abrasion of exposed conductor 80, as explained below.

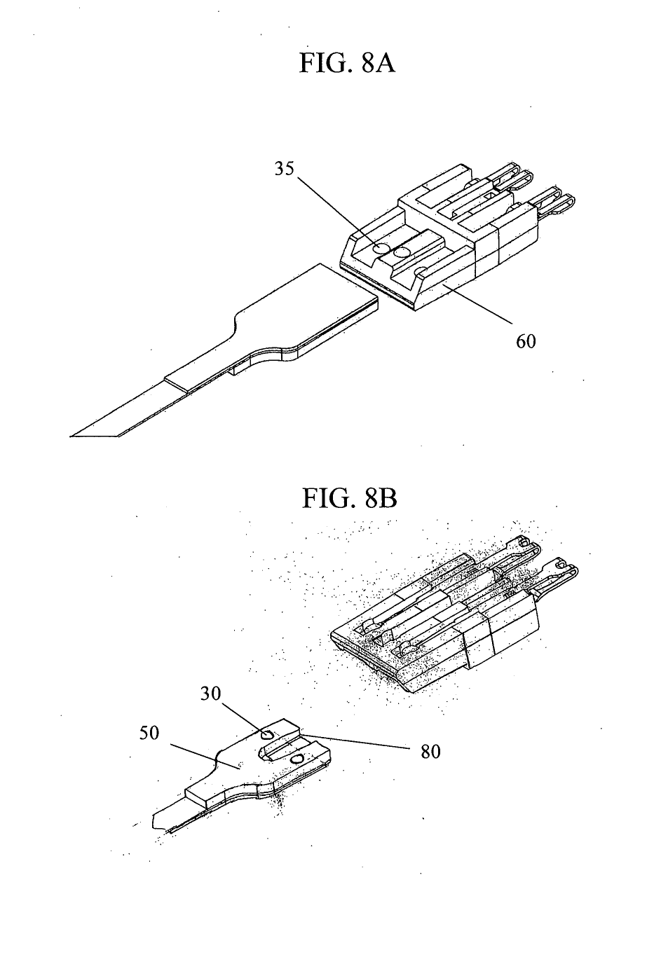

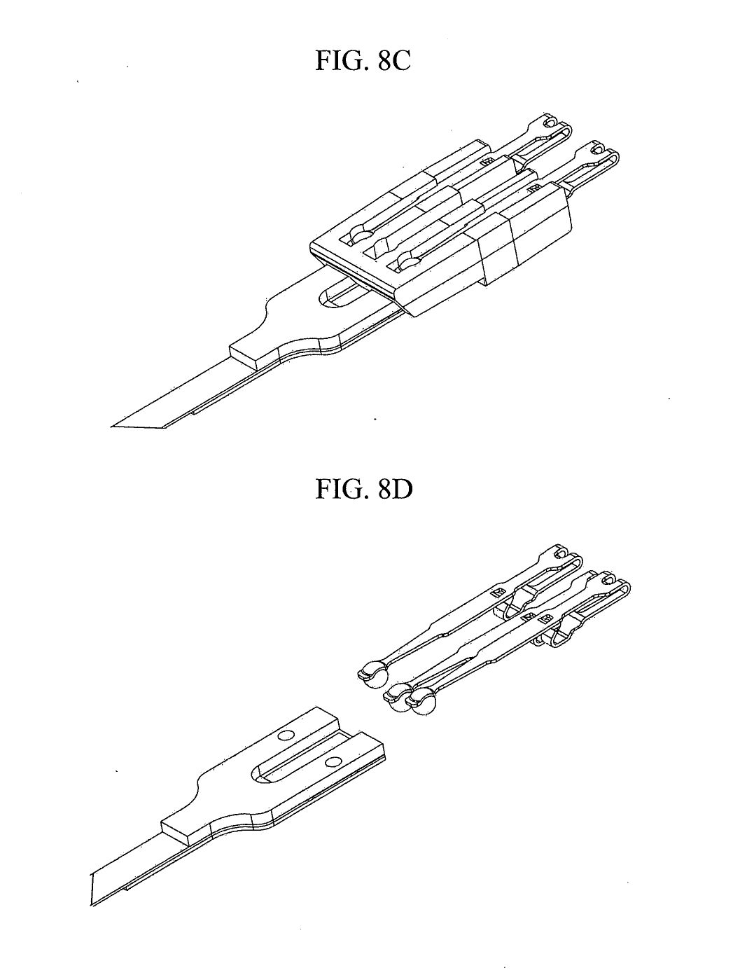

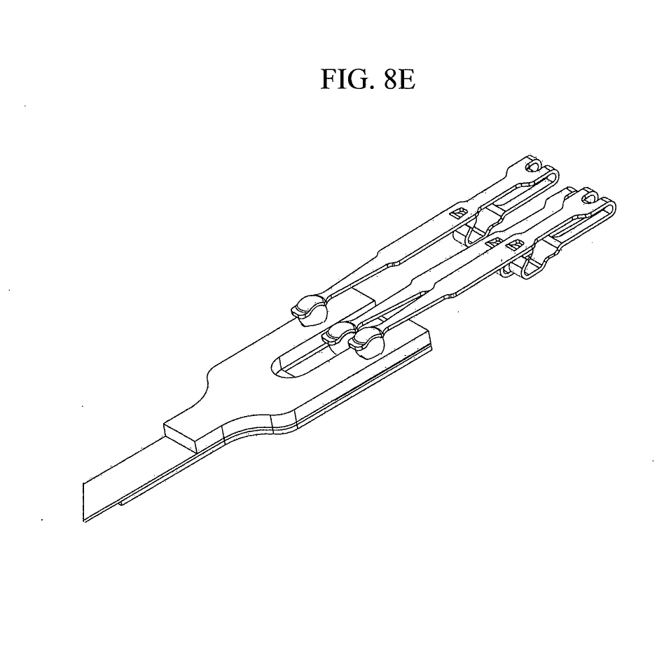

Male portion 90 also includes female locking feature 30, which is shown as preferred within stiffening element 50. In embodiments of the present invention where male portion 90 includes a female locking feature 30, female portion 100 will include a male locking feature 35, as shown in FIG. 8A, for example. Female and male locking features 30, 35 releasably lock male and female portions 90, 100 together to provide a safety break-away system, as discussed in more detail below. It is understood that the features may also be reversed so that male portion 90 includes male locking feature 35 and female portion 100 includes female locking feature 30.

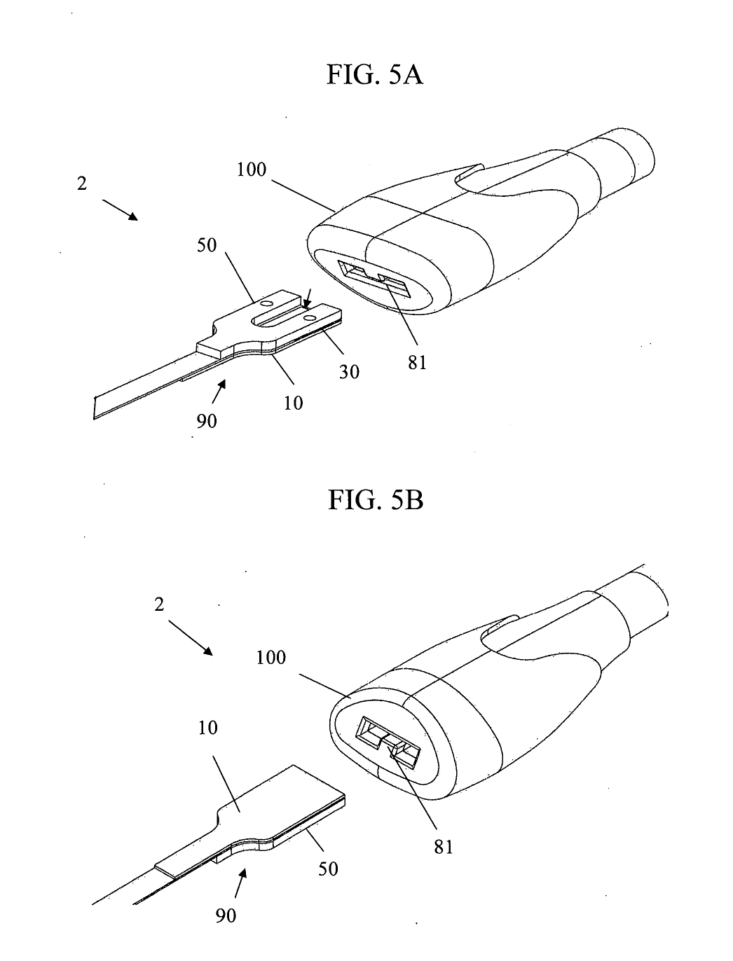

Male portion 90 also includes indentation 80. As used herein, an indention 80 includes, but is not limited to, a hole, a divot, a recess, a counterbore, a dimple, a slot, a groove, a cutout, a detent, and the like. Indentation 80 on male portion 90 will mate with protrusion 81, as shown in FIGS. 5A and 5B, for example, so that male and female portions 90, 100 fit together. Although not shown, it is understood that in some embodiments, male portion 90 includes protrusion 81 and female portion 100 includes indentation 80. As used herein, a protrusion 81 includes, but is not limited to, a bump, a rolling element, a ridge, and the like.

In one embodiment of the present invention, the insulating material (stiffening element) protects the exposed conductor(s) 15 in the mating area of the circuit by preventing abrasion of the conductor surface during handling. For example, if the cable is laid on a flat surface such as a table with the exposed side facing the table, only the insulating material will contact the table, and not the exposed conductor, thereby preventing damage. Additionally, if a user were to handle the end of the cable, the insulating material would prevent the transfer of dirt and/or oils from the user to the conductors. The stiffening element 50 is further constructed to provide increased stiffness for handling. In certain embodiments, multiple conductors 15 are present on both the first and second sides 82, 84 of the male portion 90.

In certain embodiments, a rolling contact element 60 (shown in FIG. 8A, e.g.) provides increased reliability due to the elimination of wear and damage to the conductive ink traces during a mating cycle. The increased reliability of the rolling contact element is also due to the elimination of wear and damage due to handling and vibration because the rolling contact element acts as a shock absorber. In other connectors, if the circuit is moved in relationship to the connector, such as through shock or vibration, the contacts of the connector must therefore move across the conductive surface of the circuit. In a printed ink circuit, this translates to the contact either scraping across the surface of the conductor or through the conductor. In certain embodiments, when the circuit is moved in relationship to the connector, a rolling contact element can roll across the surface of the conductive surface of the circuit, effectively moving with the circuit to prevent damage and thereby absorbing the shock or vibration.

Referring to FIGS. 5A and 5B, one embodiment of the keyed circuit interlock 2, including male and female portions 90, 92, of the present invention is shown. More particularly, it is clear that indentation 80 of male portion 90 will fit with protrusion 81 of female portion 92 so that the cable may only be engaged in one orientation. The stiffening element 50 that surrounds and creates indentation 80 provides keyed alignment to the mating connector to prevent the user from plugging the circuit in with the wrong orientation.

It is understood that cables traditionally used with ZIF (Zero Insertion Force) connectors may be plugged into the connector in two orientations but only one of them will function. This can lead to improper electrical connections and equipment damage. Interlocking features, such as indentation 80 and protrusion 81 and female and male locking features 30, 35 prevent misalignment and improper orientation of the circuit during insertion and hold it firmly in the connector during use. Alignment features can include, but are not limited to, protrusions, indent at ions, edge guides, openings of matched size, and the like. Locking features can include, but are not limited to female and male locking features as shown, spring loaded arms with detents that interlock with holes, grooves, slots, and the like. In certain embodiments, the alignment, keying, locking features, and the like can be on the first side 82 of the male portion 90, the second side 84 of the male portion 90, the female portion 100, or any combination therein.

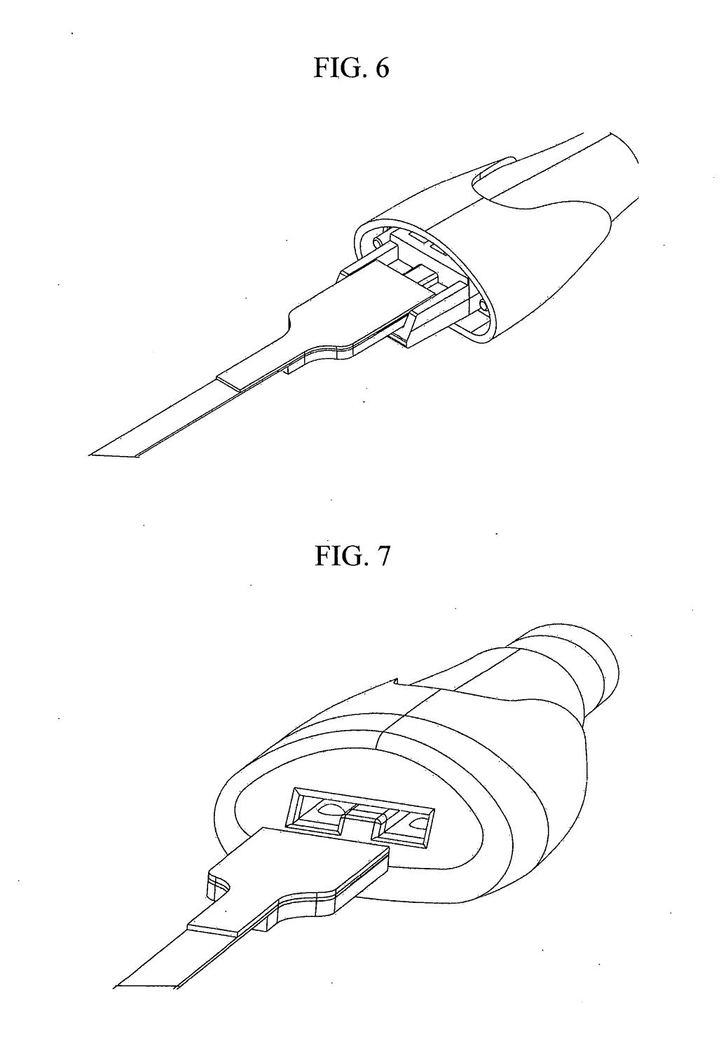

Referring to FIG. 6, one embodiment of the keyed circuit interlock 2 of the present invention is shown. More particularly, as one embodiment of the circuit, male portion 90, is inserted into the connector, female portion 100, the insulator, stiffening element 50, displaces the male locking feature 35 within the female portion 100. In certain embodiments, the male locking feature 35 comprises spring arms with formed detents. Once the circuit is fully inserted into the connector, the male locking feature 35 engages with the female locking feature 30, shown in FIGS. 4 and 5A. In certain embodiments, the female locking feature 30 comprises punched holes or detents on the stiffening element 50 to retain the circuit within the connector while the electrical connection is made. This interlocking mechanism stabilizes the connection by limiting movement of the circuit with reference to the electrical contact point within the connector. In certain embodiments, the male locking feature 35 may penetrate only the stiffening element 50 or may pass through the entire material.

Referring to FIG. 7, one embodiment of the keyed circuit interlock 2 of the present invention is shown. More particularly, in certain embodiments, the male locking feature 35 comprises rollers or the like. Referring to FIGS. 8A-8E embodiments of the keyed circuit interlock 2 of the present invention are provided. More particularly, FIG. 8A shows a top view of one embodiment of the present invention and FIG. 8B shows a bottom view of the same embodiment. In certain embodiments, a roller contact element 60, as developed by the inventor of the present invention, is used to make electrical contact, provide a locking mechanism, an alignment mechanism, or any combination thereof.

Referring to FIGS. 8C-8E, one embodiment of the keyed circuit interlock 2 of the present invention is shown. More particularly, as the circuit (male portion) is inserted into the connector (female portion), the insulator (stiffening element) displaces the locking mechanism within the connector (shown here as two ball bearings on spring arms) and once the circuit is fully inserted into the connector, the ball bearing locking mechanism engages with the locking features (shown here as punched holes) on the insulator to retain the circuit within the connector while the electrical connection is made. One advantage to this design is that there will be less friction during the engagement and disengagement of the cable, but the retention force will remain roughly the same.

In certain embodiments, to remove the circuit from the connector, sufficient force is needed in order to overcome friction between the insulator and the spring arm detents or the like to fully disengage the locking mechanism. This important feature affords the added benefit of providing a safety break-away that is often required in medical electrical connectors to prevent injury to a patient if the cable is accidentally pulled. It should be understood that in certain embodiments protrusions, indentations, or the like that are present on the male portion of the interconnection system will be mated with corresponding features on the female portion of the interconnection system.

In certain embodiments of the present invention, the connector and/or the circuit can be formed of a unitary piece. In certain embodiments, the connector and/or the circuit can be made up of modular pieces. In certain embodiments, the connector and/or the circuit can be formed by laminating two or more layers together. In certain embodiments, the stiffening elements are laminated to the conductor side of the cable that keys and interlocks. This should be differentiated from laminated electrical insulation, which is generally thin (0.001″) and is used primarily for its insulation properties and not for the features described above (e.g., alignment, keying, interlocking, retention, protection of contact surface, and the like). In certain embodiments, the stiffening elements may be formed on the circuit using an overmolding process. In certain embodiments, the stiffening elements may be applied to the circuit using plastic joining techniques such as snap fits, plastic welding, ultrasonic welding, heat staking, and the like.

In certain embodiments of the present invention, the interconnect could be designed without the stiffening element on the exposed side of the cable by designing the stiffener on the non-exposed side of the cable to have sufficient thickness to displace the locking mechanism. There, the keying and interlocking features would be included as part of the bottom stiffening element, but the protective feature for the exposed conductor would then be lost. In certain embodiments, the interconnect has stiffening elements on both sides of the connector.

In certain embodiments of the present invention, features may be added to the insulating material or stiffening elements to improve the grip (not shown) during insertion or removal such as embossments, grooves, ridges, or the like. These features may help prevent damage during the insertion and extraction process of the connectors. In certain embodiments, engraving or marking may be added to aid the user in orienting the circuit prior to insertion into the connector. While the figures herein demonstrate a single conductor for simplicity, it is understood that the invention may be easily adapted to accommodate multiple conductor designs.

In certain embodiments of the keyed interlock circuit of the present invention, a reduced material cost of the disposable portion of the interconnect is attainable. Because the disposable portion is used in the highest volume, considerable cost savings can be achieved. In certain embodiments, reduced assembly labor on the disposable portion of the interconnect is also possible. In certain embodiments, increased reliability due to elimination of wear and damage to the conductive ink traces during handling and use is obtained.

In certain embodiments, a ruggedized design prevents damage due to misuse. In certain embodiments, a reduced likelihood of counterfeit disposable sensor use is also possible. In certain embodiments, keying prevents misalignment of the circuit. In certain embodiments, the thickness of the insulating material protects the exposed conductors from wear and damage. In certain embodiments, strain relief of the interconnection point is provided by the keyed interlock circuit of the present invention. In certain embodiments, strain relief is provided by using staggered stiffeners on opposite sides of the cable. In certain embodiments, a controlled breakaway of the interconnect is possible providing added safety to the patient through a safety break-away system and preventing excess wear and/or damage to the cable.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

1. An electrical interconnection system, comprising:
a female portion; and
a male portion comprising a first side and a second side, wherein at least one conductor and at least one stiffening element is disposed on said first side, and said at least one stiffening element comprises at least one indentation, such that said at least one conductor is recessed within said at least one stiffening element.

2. The electrical interconnection system as claimed in claim 1, wherein:
said female portion comprises at least one protrusion; and
said at least one indentation of said at least one stiffening element is constructed to align with said at least one protrusion.

3. The electrical interconnection system as claimed in claim 1, wherein:
said female portion further comprises at least one protrusion;
said at least one indentation of said at least one stiffening element of said male portion is constructed to align with said at least one protrusion; and
said alignment of said at least one protrusion and said at least one indentation is such that said interconnection system is limited to only one orientation.

4. The electrical interconnection system as claimed in claim 1, wherein:
said female portion further comprises one of a female locking feature and a male locking feature;
said male portion further comprises the other of a female locking feature and a male locking feature; and
said female and male locking features are sized and dimensioned to releasably lock said male and female portions together.

5. The electrical interconnection system as claimed in claim 1, wherein said second side of said male portion comprises a stiffening element.

6. The electrical interconnection system as claimed in claim 5, wherein each of said stiffening elements of said first and second sides of said male portion comprises a length and the lengths of said stiffening elements of said first and second sides are not equal.

7. The electrical interconnection system as claimed in claim 1, wherein said stiffening element of said first side of said male portion comprises a thickness that is sufficiently thick so as to prevent abrasion of said at least one conductor of said male portion.

8. An electrical interconnection system, comprising:
a female portion; and
a male portion comprising a first side and a second side, wherein at least one stiffening element is disposed on said first side, and said stiffening element comprises at least one protrusion on which at least one conductor is disposed.

9. The electrical interconnection system as claimed in claim 8, wherein:
said female portion comprises at least one indentation; and
said at least one protrusion of said at least one stiffening element is constructed to align with said at least one indentation.

10. The electrical interconnection system as claimed in claim 8, wherein:
said female portion further comprises at least one indentation;
said at least one protrusion of said at least one stiffening element is constructed to align with said at least one indentation; and
said alignment of said at least one protrusion and said at least one indentation is such that said interconnection system is limited to only one orientation.

11. The electrical interconnection system as claimed in claim 8, wherein:
said female portion further comprises one of a female locking feature and a male locking feature;
said male portion further comprises the other of a female locking feature and a male locking feature; and
said female and male locking features are sized and dimensioned to releasably lock said male and female portions together.

12. The electrical interconnection system as claimed in claim 8, wherein said second side of said male portion comprises a stiffening element.

13. The electrical interconnection system as claimed in claim 12, wherein each of said stiffening elements of said first and second sides of said male portion comprises a length and the lengths of said stiffening elements of said first and second sides are not equal.

14. A method of electrically interconnecting, comprising the steps of:
providing a female portion;
providing a male portion comprising a first side and a second side, wherein at least one conductor is located on the first side;
providing a stiffening element on the first side of the male portion; and
aligning the female portion with the at least one conductor of the male portion.

15. The method as claimed in claim 14, wherein the stiffening element of the male portion is constructed such that the alignment of the female and male portions is limited to only one orientation.

16. The method as claimed in claim 14, wherein:
the female portion further comprises one of a female locking feature and a male locking feature;
the male portion further comprising the other of a female locking feature and a male locking feature; and
the female and male locking features are sized and dimensioned to releasably lock the male and female portions together.

17. The method as claimed in claim 14, wherein the stiffening element comprises a thickness that is sufficiently thick so as to prevent abrasion of the conductor.

18. The method as claimed in claim 14, further comprising a step of providing a stiffening element on the second side of the male portion.

19. The method as claimed in claim 18, wherein each of the stiffening elements of the first and second sides of the male portion comprises a length and the lengths of the stiffening elements of the first and second sides are not equal.

20. The method as claimed in claim 14, wherein the male conductor further comprises at least one conductor located on the second side.
